(19) United States
(12) Patent Application Publication
(10) Pub. No.: US 2009/0175133 A1
(43) Pub. Date: Jul. 9, 2009

(54) Electronic Calendar Apparatus

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/968,773

(22) Filed: Jan. 3, 2008

(51) Int. Cl. G04G 9/00

(52) U.S. Cl. 368/30; 368/29

(57) ABSTRACT

This invention provides an electronic calendar apparatus which comprises a display screen of at least 4.9 inches in diagonal dimension, a clock for generating date and time information, a nonvolatile storage device configured to store scheduling information, and a processing unit configured to control the display of the stored scheduling information on the display screen based on the date and time information generated by the clock, wherein the display screen, the clock, the nonvolatile memory and the processing unit are enclosed in a single enclosure, so that the electronic calendar apparatus can be either placed on a desk or hung on a wall.

### BACKGROUND

The present invention relates generally to calendar and scheduling devices, and more specifically, to an electronic calendar apparatus.

Traditional paper calendars, while low cost and can record calendar events as well as display beautiful illustrations, lacks multimedia reminder functions. Even though one can write down an event on a traditional paper calendar, if he or she fails to look at it the traditional paper calendar still does not serve as a reminder. On the other hand, there are numerous conventional digital photo frames in the marketplace for displaying digital photos supplied either by local memories or through the Internet. But they only display digital photos. The conventional digital photo frame is essentially a simple computer, having a central processing unit (CPU), memory, LCD display and a simple operating system. The simple computer in the conventional digital photo frame should have enough computing power to handle additional tasks such as those required by a calendar. As such, what is desired is to have a digital photo frame incorporating clock and calendar functions, and providing both video and audio alerts based on the calendar.

### SUMMARY

In view of the foregoing, the present invention provides an electronic calendar apparatus which comprises a display screen of at least 4.9 inches in diagonal dimension, a clock for generating date and time information, a nonvolatile storage device configured to store scheduling information, and a processing unit configured to control the display of the stored scheduling information on the display screen based on the date and time information generated by the clock, wherein the display screen, the clock, the nonvolatile memory and the processing unit are enclosed in a single enclosure, so that the electronic calendar apparatus can be either placed on a desk or hung on a wall. The electronic calendar apparatus may also include a loudspeaker being controlled by the processing unit for producing audio messages based on the clock and the stored scheduling information.

The construction and method of operation of the invention, however, together with additional objects and advantages thereof will be best understood from the following description of specific embodiments when read in connection with the accompanying drawings.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

FIG. 1 is a perspective view of a desktop electronic calendar according to one embodiment of the invention.

FIG. 2 is a block diagram illustrating a circuit implementation of the desktop electronic calendar of FIG. 1.

### DESCRIPTION

The present invention discloses an electronic calendar apparatus, which can store and display scheduling information by a month, a week or a day. The electronic calendar apparatus keeps time and can generate an audio message based on the time and the stored scheduling information, which are written to a non-volatile storage device in the electronic calendar apparatus.

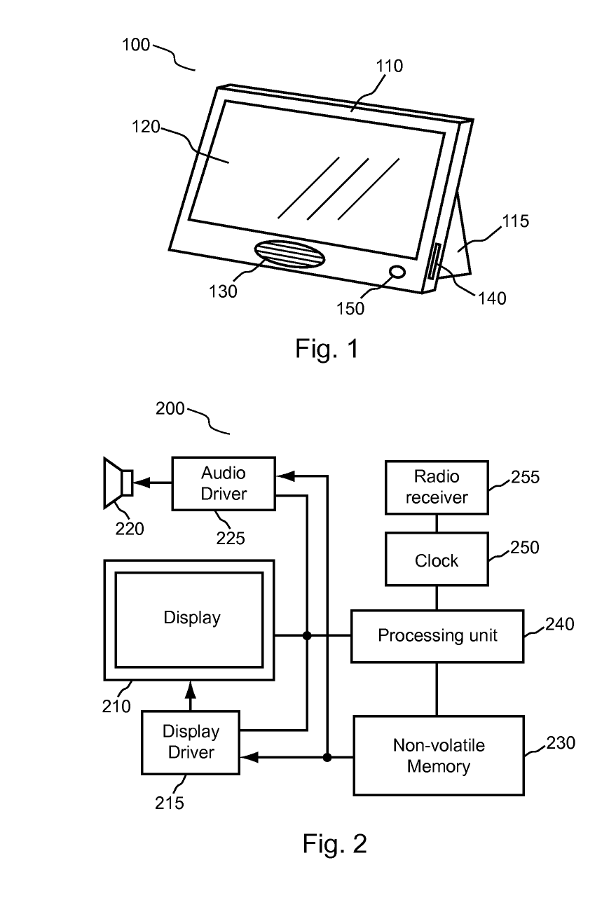

FIG. 1 is a perspective view of a desktop electronic calendar apparatus 100 according to one embodiment of the invention. The desktop electronic calendar apparatus 100 comprises a picture-frame-like enclosure 110 which holds a liquid crystal display (LCD) 120, a loudspeaker 130, memory slot 140 and a mode selection button 150. A support 115 keeps the enclosure 110 in an up-right position. The LCD 120 is used to display calendar information which can be organized into monthly, weekly or daily view. In the monthly view, the electronic calendar apparatus 100 looks very much like a traditional paper calendar showing all the days in a month. In the weekly view, seven days following the current date is displayed, so that certain amount of scheduling information can be display in this view. In the daily view, only current day scheduling information is displayed. Switching among these views are controlled by the mode selection button 150, i.e., at a press of the button 150, the view can be switched from a monthly to a weekly view, a weekly to a daily view or a daily view back to a monthly view.

Referring to FIG. 1 again, since the electronic calendar apparatus 100 is used as a desktop device, the LCD 120 cannot be too small. Like conventional digital photo frames, the LCD 120 should be five inch or larger in diagonal dimension. For the same reason, the loudspeaker 130 is different from earphones and has to be able to produce a laudable enough sound to be heard across a regular sized room in a residential house. In order to lower the cost, the electronic calendar apparatus 100 does not have data entry function on itself. The storage means for storing the scheduling information is a removable Flash memory chip. The scheduling information is written to the Flash memory chip through a personal computer when the Flash memory chip is removed from the electronic calendar apparatus 100 and connected to the personal computer. A skilled artisan may appreciate that the storage means can also be written by the personal computer through a universal serial bus (USB), and in this case, the storage means may be a disk drive, and need not be removable from the electronic calendar apparatus 100.

FIG. 2 is a block diagram illustrating a circuit implementation 200 of the desktop electronic calendar of FIG. 1. The circuit implementation 200 includes a display 210, a display driver 215, a loudspeaker 220, an audio driver 225, a non-volatile memory 230, a processing unit 240, a clock 250 and a radio receiver 255. The display 210 may be implemented by a LCD with an appropriate display driver 215. The non-volatile memory 230 may be implemented by a removable Flash memory chip as described for FIG. 1. The non-volatile memory 230 stores scheduling information such as appointment or meeting reminders, etc. The non-volatile memory 230 supplies data to the display driver 215 and the audio driver 225. How the scheduling information is displayed, i.e., in monthly, weekly or daily view, is controlled by the processing unit 240. The processing unit 240 also takes in date and time information generated by the clock 250, and determines whether a particular piece of scheduling information should be output to the display and/or the loudspeaker 220 based on the scheduling information itself and the date and time information. For instance, if following information: a meeting at 9 am, Jan. 2, 2008 and reminding me one day earlier, is stored in the non-volatile memory 230, when the clock 240 reaches Jan. 1, 2008, 9 am, the processing unit 240 will instruct the non-volatile memory 230 to send the meeting reminder to the display 210. Another example may be a user stores a routine reminder such as reminding me at 8 am every Wednesday to go to school. When the clock 240 reaches a Wednesday 8 am, the processing unit 240 will instruct the non-volatile memory 230 to send an audio message to the loudspeaker 220. The audio message may be pre-recorded audio data stored in the non-volatile memory 230 or generated by the processing unit 240 based on text messages stored in the non-volatile memory 230. Apparently a digital clock can readily supply date and time information to the processing unit 240. Referring again to FIG. 2, the radio receiver 255 is coupled to the clock 250 for receiving radio signals that can synchronize the clock 250 with a reference clock (not shown), so that the clock 250 can always keep accurate date and time information.

The above illustrations provide many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. An electronic picture frame for displaying calendar information comprising:
a display screen constantly displaying one or more calendar related images when the electronic picture frame being powered up and left alone;
a clock for generating date and time information;
a nonvolatile storage device configured to store scheduling information; and
a processing unit configured to control the display of the stored scheduling information on the display screen based on the date and time information generated by the clock,
wherein the display screen, the clock, the nonvolatile memory and the processing unit are enclosed in a single stationary enclosure.

2. The electronic picture frame of claim 1, wherein the display screen is a liquid crystal display (LCD).

3. The electronic picture frame of claim 1, wherein the clock is a digital clock.

4. The electronic picture frame of claim 3, wherein the digital clock comprises a radio receiver for synchronizing the digital clock with a reference clock.

5. The electronic picture frame of claim 1, wherein the display screen displays the time information generated by the clock.

6. The electronic picture frame of claim 1, wherein the nonvolatile storage device is a Flash memory.

7. The electronic picture frame of claim 6, wherein the Flash memory is detachable from the electronic calendar apparatus for being programmed by a personal computer.

8. The electronic picture frame of claim 1 further comprising a loudspeaker controlled by the processing unit for producing audio messages based on the clock and stored scheduling information.

9. The electronic picture frame of claim 1 further comprising an electronic connection for linking a personal computer to the electronic calendar apparatus for programming the nonvolatile storage memory in the electronic calendar apparatus.

10. An electronic picture frame for displaying calendar information comprising:
a display screen constantly displaying one or more calendar related images when the electronic picture frame being powered up and left alone;
a clock for generating date and time information;
a nonvolatile storage device configured to store scheduling information; and
a processing unit configured to control the display of the stored scheduling information on the display screen based on the date and time information generated by the clock,
wherein the display screen, the clock, the nonvolatile memory and the processing unit are enclosed in a single stationary enclosure and the time information is displayed by the display screen.

11. The electronic picture frame of claim 10, wherein the display screen is a liquid crystal display (LCD).

12. The electronic picture frame of claim 10, wherein the clock is a digital clock.

13. The electronic picture frame of claim 12, wherein the digital clock comprises a radio receiver for synchronizing the digital clock with a reference clock.

14. The electronic picture frame of claim 10, wherein the nonvolatile storage device is a Flash memory.

15. The electronic picture frame of claim 14, wherein the Flash memory is detachable from the electronic calendar apparatus for being programmed by a personal computer.

16. The electronic picture frame of claim 10 further comprising a loudspeaker controlled by the processing unit for producing audio messages based on the clock and stored scheduling information.

17. The electronic picture frame of claim 10 further comprising an electronic connection for linking a personal computer to the electronic calendar apparatus for programming the nonvolatile storage memory in the electronic calendar apparatus.

18. An electronic picture frame for displaying calendar information comprising:
a display screen constantly displaying one or more calendar related images when the electronic picture frame being powered up and left alone;
a clock for generating date and time information;
a nonvolatile storage device configured to store scheduling information;
a processing unit configured to control the display of the stored scheduling information on the display screen based on the date and time information generated by the clock; and
a loudspeaker controlled by the processing unit for producing audio messages based on the clock and stored scheduling information,
wherein the display screen, the clock, the nonvolatile memory and the processing unit are enclosed in a single stationary enclosure.

19. The electronic picture frame of claim 18, wherein the display screen is a liquid crystal display (LCD).

20. The electronic picture frame of claim 18, wherein the clock is a digital clock and synchronized with a reference clock by radio signals.
